(19) United States
(12) Patent Application Publication
(10) Pub. No.: US 2025/0292946 A1
(43) Pub. Date: Sep. 18, 2025

(54) LAMINATED INDUCTOR

(71) Applicant: Murata Manufacturing Co., Ltd., Kyoto-fu (JP)

(72) Inventor: Naoki UEDA, Nagaokakyo-shi (JP)

(73) Assignee: Murata Manufacturing Co., Ltd., Kyoto-fu (JP)

(21) Appl. No.: 19/078,411

(22) Filed: Mar. 13, 2025

(30) Foreign Application Priority Data
Mar. 14, 2024 (JP) 2024-040050

(51) Int. Cl. H01F 27/28; H01F 27/32

(52) U.S. Cl. CPC H01F 27/2847; H01F 27/323

(57) ABSTRACT

A laminated inductor capable of suppressing deterioration in reliability due to structural defects such as cracks includes a laminated body in which insulating layers are laminated in a lamination direction and a coil is inside; and first and second external electrodes on an outer surface of the laminated body and electrically connected to the coil. The coil is configured by electrically connecting coil conductor layers laminated in the lamination direction together with the insulating layer. The coil conductor layers have M+N layers (M and N are natural numbers) of first coil conductor layers continuous in the lamination direction. Each of the first coil conductor layers has a first parallel portion. The first parallel portions of the first coil conductor layers adjacent in the lamination direction are connected in parallel with at least two via conductors interposed therebetween.

### CROSS-REFERENCE TO RELATED APPLICATION

This application claims benefit of priority to Japanese Patent Application No. 2024-040050, filed Mar. 14, 2024, the entire content of which is incorporated herein by reference.

### BACKGROUND

### Technical Field

The present disclosure relates to a laminated inductor.

### Background Art

Japanese Patent Application Laid-Open No. 2013-162101 discloses a laminated inductor including a laminated body including a plurality of insulator layers, an external electrode formed outside the laminated body, and a coil conductor formed in a spiral shape inside the laminated body, in which the coil conductor has an extended portion electrically connected to the external electrode and a coil main body other than the extended portion. The coil conductor has a conductor pattern formed in the insulator layer and a via hole conductor penetrating the insulator layer and electrically connecting the plurality of conductor patterns. A conductor pattern formed in one part of the insulator layers is a C-shaped pattern including four vertices of a substantially rectangular shape and missing one side in part, and a conductor pattern formed in another part of the insulator layers is an I-shaped pattern corresponding to a part of one side missing in the C-shaped pattern in the substantially rectangular shape. A conductor pattern constituting the coil main body is only the C-shaped pattern and the I-shaped pattern. The coil main body has a partial structure in which two or more layers of C-shaped patterns are continuously laminated, and the number of the C-shaped patterns in the coil main body is larger than the number of the I-shaped patterns.

### SUMMARY

Meanwhile, the manufacturing of the laminated inductor may include a step of cutting the laminated body block by a method such as press-cutting or dicer cutting. In the laminated inductor described in Japanese Patent Application Laid-Open No. 2013-162101, stress generated during cutting the laminated body block may cause structural defects such as cracks at the extended conductor itself or at the interface between the extended conductor and the insulating layer. The structural defect occurring in the laminated inductor increases a risk of disconnection or the like during use of the laminated inductor, and thus reliability of the laminated inductor is deteriorated.

The present disclosure provides a laminated inductor capable of suppressing a deterioration in reliability due to structural defects such as cracks.

The laminated inductor according to the present disclosure includes a laminated body in which a plurality of insulating layers are laminated in a lamination direction and a coil is provided inside; and a first external electrode and a second external electrode provided on an outer surface of the laminated body and electrically connected to the coil. The coil is configured by electrically connecting a plurality of coil conductor layers laminated in the lamination direction together with the insulating layer. The plurality of coil conductor layers have M+N layers (M and N are natural numbers) of first coil conductor layers continuous in the lamination direction. Each of the first coil conductor layers has a first parallel portion. The first parallel portions of the first coil conductor layers adjacent in the lamination direction are connected in parallel with at least two via conductors interposed therebetween. M layers in the first coil conductor layers are each a first extended layer having a first extended conductor connected to the first external electrode, and N layers are each a first non-extended layer not having the first extended conductor.

In the first aspect, M is a natural number of 2 or more, and at least one layer of the first non-extended layer is present between at least one set of the first extended layers in the lamination direction.

In a second aspect, when viewed from the lamination direction, a portion constituting a current path in a circling portion of the first extended layer is the same in orientation and shape as a portion constituting a current path in a circling portion of the first non-extended layer.

The present disclosure can provide a laminated inductor capable of suppressing deterioration in reliability due to structural defects such as cracks.

### BRIEF DESCRIPTION OF THE DRAWINGS

FIG. 1 is a perspective view schematically illustrating an example of a laminated inductor according to a first embodiment of the present disclosure;

FIG. 2 is a view illustrating the laminated inductor illustrated in FIG. 1 in a perspective view in a height direction;

FIG. 3 is an exploded plan view schematically illustrating an example of an internal structure of the laminated inductor illustrated in FIG. 1;

FIG. 4 is a view illustrating the laminated inductor illustrated in FIG. 1 in a perspective view in a width direction;

FIG. 5 is a view illustrating a laminated inductor of a comparative example in a perspective view in a height direction;

FIG. 6 is a view illustrating a laminated inductor of a comparative example in a perspective view in a width direction;

FIG. 7 is a schematic view illustrating a first extended conductor in an enlarged manner in a sectional taken along line VII-VII in FIG. 5;

FIG. 8 is an exploded plan view schematically illustrating an example of a laminated inductor according to a second embodiment of the present disclosure;

FIG. 9 is an exploded plan view schematically illustrating an example of a laminated inductor according to a third embodiment of the present disclosure;

FIG. 10 is an exploded plan view schematically illustrating an example of a laminated inductor according to a forth embodiment of the present disclosure; and

FIG. 11 is an exploded plan view schematically illustrating an example of a laminated inductor according to a fifth embodiment of the present disclosure.

### DETAILED DESCRIPTION

A laminated inductor according to the present disclosure will be described below. The present disclosure is not limited to the following configuration, and may be modified as appropriate without changing the gist of the present disclosure. The present disclosure also includes a combination of a plurality of individual preferable configurations described below.

In the present specification, the terms indicating the relationship between elements (for example, “vertical”, “parallel”, and “orthogonal”) and the terms indicating the shape of an element are not expressions indicating only a strict meaning, but are expressions meaning to include a substantially equivalent range, for example, a difference of about several %.

The embodiments shown below are mere examples, and the configurations can be replaced or combined in part in the different embodiments. In the second and subsequent embodiments, the description of matters that are common to the first embodiment will be omitted, and only the differences will be described. In particular, the same actions and effects achieved by the same configurations will not be sequentially described for each embodiment.

The drawings shown below are schematic views, and dimensions, scales of aspect ratios, and the like may be different from those of actual products.

### First Embodiment

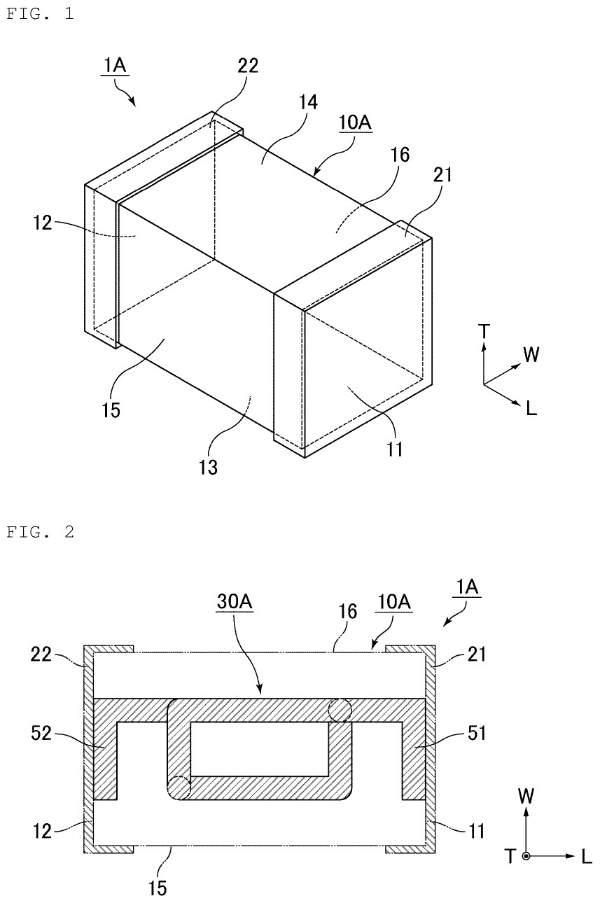

FIG. 1 is a perspective view schematically illustrating an example of a laminated inductor according to the first embodiment of the present disclosure.

A laminated inductor 1A illustrated in FIG. 1 includes a laminated body 10A, a first external electrode 21, and a second external electrode 22. The laminated body 10A has, for example, a rectangular parallelepiped shape or a substantially rectangular parallelepiped shape having six surfaces. Although not illustrated in FIG. 1, the laminated body 10A is formed by laminating a plurality of insulating layers in a lamination direction, and has a coil therein. Each of the first external electrode 21 and the second external electrode 22 is electrically connected to the coil.

In the laminated inductor 1A and the laminated body 10A, the length direction, the height direction, and the width direction are referred to as an L direction, a T direction, and a W direction in FIG. 1. Herein, the length direction L, the height direction T, and the width direction W are orthogonal to each other.

In the example illustrated in FIG. 1, the laminated body 10A has a first end surface 11 and a second end surface 12 facing each other in the length direction L, a first main surface 13 and a second main surface 14 facing each other in the height direction T, and a first side surface 15 and a second side surface 16 facing each other in the width direction W.

Although not illustrated in FIG. 1, the laminated body 10A is preferably rounded at the corner portion and the ridge portion. The corner portion of the laminated body 10A is a portion where three surfaces of the laminated body 10A intersect, and the ridge portion of the laminated body 10A is a portion where two surfaces of the laminated body 10A intersect.

The first external electrode 21 and the second external electrode 22 are provided on the outer surface of the laminated body 10A.

For example, as illustrated in FIG. 1, the first external electrode 21 covers the entire first end surface 11 of the laminated body 10A, and extends from the first end surface 11 to cover a part of the first main surface 13, a part of the second main surface 14, a part of the first side surface 15, and a part of the second side surface 16.

For example, as illustrated in FIG. 1, the second external electrode 22 covers the entire second end surface 12 of the laminated body 10A, and extends from the second end surface 12 to cover a part of the first main surface 13, a part of the second main surface 14, a part of the first side surface 15, and a part of the second side surface 16.

When the laminated inductor 1A in which the first external electrode 21 and the second external electrode 22 are disposed as described above is mounted on a substrate, any one of the first main surface 13, the second main surface 14, the first side surface 15, and the second side surface 16 of the laminated body 10A is a mounting surface.

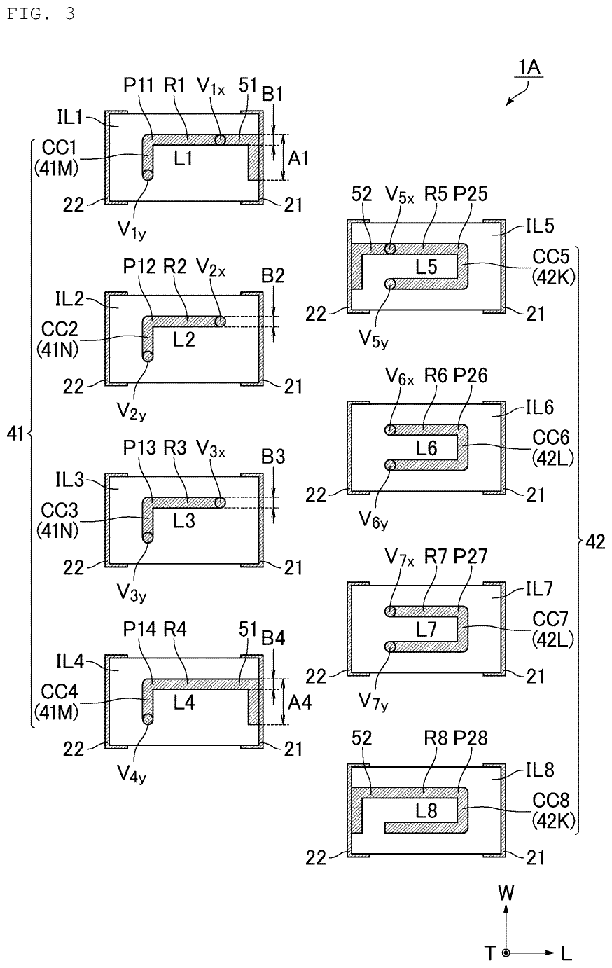

FIG. 2 is a view illustrating the laminated inductor illustrated in FIG. 1 in a perspective view in a height direction.

In the laminated inductor 1A illustrated in FIG. 2, the laminated body 10A has a coil 30A therein.

The coil 30A has a first extended conductor 51 and a second extended conductor 52 to be described later. The coil 30A is connected to the first external electrode 21 with the first extended conductor 51 interposed therebetween. The coil 30A is connected to the second external electrode 22 with the second extended conductor 52 interposed therebetween.

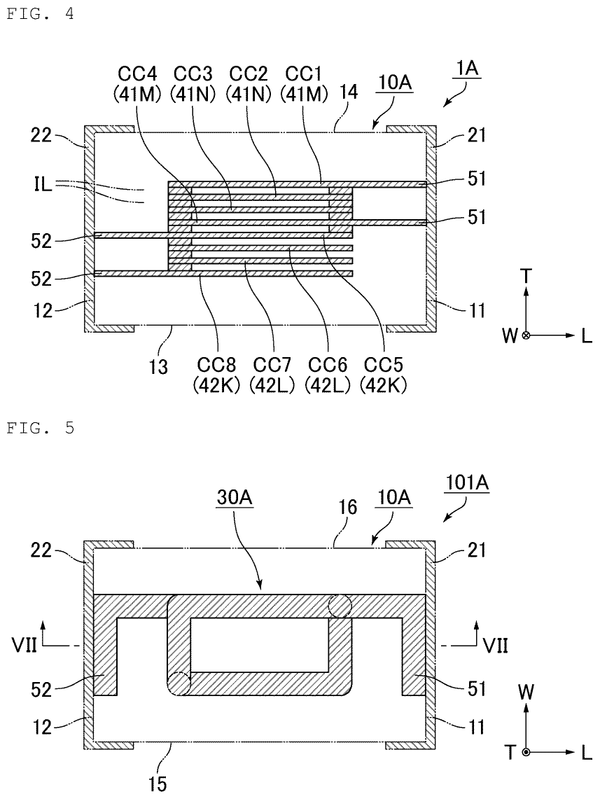

FIG. 3 is an exploded plan view schematically illustrating an example of an internal structure of the laminated inductor illustrated in FIG. 1.

As illustrated in FIG. 3, the laminated body 10A (refer to FIG. 1) is configured by laminating a plurality of insulating layers IL1, IL2, IL3, IL4, IL5, IL6, IL7, and IL8 in the height direction T from the first main surface 13 (refer to FIG. 1) toward the second main surface 14 (refer to FIG. 1) of the laminated body 10A. Hereinafter, the insulating layers IL1, IL2, IL3, IL4, IL5, IL6, IL7, and IL8 are also collectively referred to as an insulating layer IL.

In FIG. 3, the insulating layer IL1 is disposed on the upper side (the second main surface 14 side of the laminated body 10A) in the lamination direction (herein, the height direction T), the insulating layer IL8 is disposed on the lower side (the first main surface 13 side of the laminated body 10A) in the lamination direction, and of the main surfaces of the respective insulating layers IL, the main surface on the negative side (the back side in FIG. 3) in the height direction T is disposed on the lower side in the lamination direction, and the main surface on the positive side (the front side in FIG. 3) in the height direction T is disposed on the upper side in the lamination direction.

Examples of a constituent material of each insulating layer IL include a magnetic material such as a ferrite material.

As illustrated in FIG. 3, the insulating layers IL1, IL2, IL3, IL4, IL5, IL6, IL7, and IL8 are respectively provided with coil conductor layers CC1, CC2, CC3, CC4, CC5, CC6, CC7, and CC8. Hereinafter, the coil conductor layers CC1, CC2, CC3, CC4, CC5, CC6, CC7, and CC8 are also collectively referred to as a coil conductor layer CC.

The coil conductor layers CC1, CC2, CC3, CC4, CC5, CC6, CC7, and CC8 are respectively provided on the main surfaces of the insulating layers IL1, IL2, IL3, IL4, IL5, IL6, IL7, and IL8, specifically, on the main surface on the positive direction side in the height direction T (the front side of the paper in FIG. 3).

The plurality of coil conductor layers CC laminated in the lamination direction (herein, the height direction T) together with the insulating layer IL are electrically connected to constitute the coil 30A (refer to FIG. 2).

The coil conductor layer CC1 of the first layer L1 includes the circling portion R1 and the first extended conductor 51. The insulating layer IL1 of the first layer L1 is provided with via conductors V1x and Vy connecting the coil conductor layer CC1 and the coil conductor layer CC2.

The coil conductor layer CC2 of the second layer L2 includes the circling portion R2. The insulating layer IL2 of the second layer L2 is provided with via conductors V2x and V2y connecting the coil conductor layer CC2 and the coil conductor layer CC3.

The coil conductor layer CC3 of the third layer L3 includes the circling portion R3. The insulating layer IL3 of the third layer L3 is provided with via conductors V3x and V3y connecting the coil conductor layer CC3 and the coil conductor layer CC4.

The coil conductor layer CC4 of the fourth layer L4 includes the circling portion R4 and the first extended conductor 51. The insulating layer IL4 of the fourth layer L4 is provided with a via conductor V4y connecting the coil conductor layer CC4 and the coil conductor layer CC5.

The coil conductor layer CC5 of the fifth layer L5 includes the circling portion R5 and the second extended conductor 52. The insulating layer IL5 of the fifth layer L5 is provided with via conductors V5x and V5y connecting the coil conductor layer CC5 and the coil conductor layer CC6.

The coil conductor layer CC6 of the sixth layer L6 includes the circling portion R6. The insulating layer IL6 of the sixth layer L6 is provided with via conductors V6x and V6y connecting the coil conductor layer CC6 and the coil conductor layer CC7.

The coil conductor layer CC7 of the seventh layer L7 includes the circling portion R7. The insulating layer IL7 of the seventh layer L7 is provided with via conductors V7x and V7y connecting the coil conductor layer CC7 and the coil conductor layer CC8.

The coil conductor layer CC8 of the eighth layer L8 includes the circling portion R8 and the second extended conductor 52.

Hereinafter, the circling portions R1, R2, R3, R4, R5, R6, R7, and R8 are collectively referred to as a circling portion R.

The circling portion R constitutes a circling portion of the coil 30A when viewed from the coil axial direction (herein, the height direction T).

Hereinafter, the via conductors V1x, Vy, V2x, V2y, V3x, V3y, V4y, V5x, V5y, V6x, V6y, V7x, and V7y are collectively referred to as a via conductor V.

The via conductor V is provided so as to penetrate the insulating layer IL in the lamination direction (herein, the height direction T).

A land connected to the via conductor V may be provided on the main surface of the insulating layer IL. In this case, the size of the land may be slightly larger than the line width of the coil conductor layer CC excluding the land portion.

Examples of the constituent material of each coil conductor layer CC (including the land) and each via conductor V include Ag, Au, Cu, Pd, Ni, Al, and an alloy containing at least one of these metals.

When the insulating layers IL configured as illustrated in FIG. 3 are laminated in the height direction T, the coil conductor layer CC is electrically connected with the via conductor V interposed therebetween. As a result, in the laminated body 10A, as illustrated in FIG. 2, a solenoid coil 30A having a coil axis extending in the height direction T is formed.

Although not illustrated in FIG. 3, the laminated body 10A preferably includes one or more insulating layers IL not provided with the coil conductor layer CC on the first main surface 13 side. Similarly, the laminated body 10A preferably includes one or more insulating layers IL not provided with the coil conductor layer CC on the second main surface 14 side. The same applies to the following embodiments.

In the laminated inductor of the present disclosure, the plurality of coil conductor layers includes M+N layers of the first coil conductor layers continuous in the lamination direction (herein, the height direction T). M and N are natural numbers. Each of the first coil conductor layers has a first parallel portion, and the first parallel portions of the first coil conductor layers adjacent in the lamination direction are connected in parallel with at least two via conductors interposed therebetween.

In the laminated inductor 1A illustrated in FIG. 3, four layers of the coil conductor layers CC1, CC2, CC3, and CC4 are the first coil conductor layers 41. That is, M+N=4 in the laminated inductor 1A illustrated in FIG. 3.

In the laminated inductor 1A, the coil conductor layers CC1, CC2, CC3, and CC4 have first parallel portions P11, P12, P13, and P14, respectively. Hereinafter, the first parallel portion is also collectively referred to as P1.

The first parallel portion P11 of the coil conductor layer CC1 and the first parallel portion P12 of the coil conductor layer CC2 are connected in parallel with the via conductors V1x and Vy interposed therebetween. Similarly, the first parallel portion P12 of the coil conductor layer CC2 and the first parallel portion P13 of the coil conductor layer CC3 are connected in parallel with the via conductors V2x and V2y interposed therebetween. In addition, the first parallel portion P13 of the coil conductor layer CC3 and the first parallel portion P14 of the coil conductor layer CC4 are connected in parallel with via conductors V3x and V3y interposed therebetween.

In the laminated inductor 1A, the entire circling portion R1 of the coil conductor layer CC1 is the first parallel portion P11. Similarly, the entire circling portion R2 of the coil conductor layer CC2 is the first parallel portion P12. In addition, the entire circling portion R3 of the coil conductor layer CC3 is the first parallel portion P13. In addition, the entire circling portion R4 of the coil conductor layer CC4 is the first parallel portion P14.

In the laminated inductor 1A, only both ends of the first parallel portion P1 are connected to the first parallel portion P1 adjacent to each other with the via conductor V interposed therebetween, but a portion other than both ends of the first parallel portion P1 may also be connected to the first parallel portion P1 adjacent to each other with the via conductor interposed therebetween. In this case, the first parallel portions P1 of the adjacent first coil conductor layers 41 are connected to each other with three or more via conductors interposed therebetween. In this manner, the first parallel portions P1 of the adjacent first coil conductor layers 41 may be connected in parallel with at least two via conductors interposed therebetween. Like the laminated inductor 1A, the first parallel portions P1 of the adjacent first coil conductor layers 41 may be connected in parallel with two via conductors interposed therebetween.

FIG. 4 is a view illustrating the laminated inductor illustrated in FIG. 1 in a perspective view in a width direction.

M layers in the first coil conductor layer 41 are a first extended layer 41M having a first extended conductor 51 connected to the first external electrode 21. As illustrated in FIGS. 3 and 4, in the laminated inductor 1A, two layers of the coil conductor layers CC1 and CC4 are the first extended layer 41M. That is, in the laminated inductor 1A, M=2.

Among the first coil conductor layers 41, the N layer is the first non-extended layer 41N that does not have the first extended conductor 51 connected to the first external electrode 21. As illustrated in FIGS. 3 and 4, in the laminated inductor 1A, two layers of the coil conductor layers CC2 and CC3 are the first non-extended layer 41N. That is, in the laminated inductor 1A, N=2.

As illustrated in FIG. 4, actually, a boundary is not visually recognized between the adjacent insulating layers IL.

Hereinafter, effects of the first coil conductor layer 41 having the first non-extended layer 41N will be described.

The manufacturing of the laminated inductor may include a step of cutting the laminated body block by a method such as press-cutting or dicer cutting. Hereinafter, there will be described as an example a case where the step of manufacturing the laminated inductor 1A includes a step of cutting the laminated body block along the height direction T so that the first end surface 11 of the laminated body 10A becomes a cut surface. When the laminated body block is cut, stress is generated in a traveling direction of the cutting blade. The first extended conductor 51 contains a metal component such as Ag, and thus the first extended conductor 51 has a higher elastic modulus and a smaller breaking strain than the insulating layer IL including a ferrite material or the like. Therefore, when the number of the first extended conductors 51 present on the cut surface is large, the stress generated in the traveling direction of the cutting blade increases the risk of generation of structural defects such as cracks at the first extended conductor 51 itself or at the interface between the first extended conductor 51 and the insulating layer IL.

As illustrated in FIGS. 3 and 4, in the laminated inductor 1A, of the four layers of the first coil conductor layers 41, two layers are the first extended layers 41M, and two layers are first non-extended layers 41N. In contrast, in a laminated inductor 101A of a comparative example to be described later, among four layers of the first coil conductor layers 41, the four layers are the first extended layers 41M. As compared with the laminated inductor 101A of the comparative example, in the laminated inductor 1A, the number of the first extended conductors 51 is smaller in the traveling direction of the cutting blade. Therefore, it is possible to reduce the risk of generation of structural defects such as cracks in the laminated inductor 1A due to the stress generated in the traveling direction of the cutting blade. As described above, in the laminated inductor 1A, deterioration in reliability due to structural defects such as cracks is suppressed.

In addition, in the laminated inductor 1A, as compared with the laminated inductor 101A of the comparative example, providing the first non-extended layer 41N can reduce the number of overlapping of the first extended conductors 51 in the lamination direction (herein, the height direction T), and thus the impedance of the laminated inductor 1A can be increased.

In the laminated inductor of the present disclosure, M is a natural number of 2 or more, and it is preferable that at least one layer of the first non-extended layers 41N is present between at least one set of the first extended layers 41M in the lamination direction. As illustrated in FIGS. 3 and 4, in the laminated inductor 1A, M is 2, and the coil conductor layer CC2 and the coil conductor layer CC3 that are the first non-extended layer 41N are present between the coil conductor layer CC1 and the coil conductor layer CC4 that are the first extended layer 41M. When at least one layer of the first non-extended layers 41N is present between at least one set of the first extended layers 41M in the lamination direction, multiple insulating layers IL including ferrite or the like having a low elastic modulus and a large breaking strain are sandwiched between the first extended layers 41M. Therefore, stress concentration on the first extended conductor 51 in the step of cutting the laminated body block can be suppressed, thus allowing to further reduce the risk of generation of structural defects such as cracks in the laminated inductor 1A.

In the laminated inductor of the present disclosure, M+N is a natural number of 3 or more, and it is preferable that the first extended layer 41M is not continuous in two or more layers in the lamination direction. As illustrated in FIGS. 3 and 4, in the laminated inductor 1A, M+N is 4, and the coil conductor layer CC1 and the coil conductor layer CC4 that are the first extended layer 41M are not continuous in the lamination direction. When two or more layers of the first extended layers 41M are not continuous in the lamination direction, the first non-extended layer 41N is present between the first extended layers 41M. Therefore, multiple insulating layers IL including ferrite or the like having a low elastic modulus and a large breaking strain are sandwiched between the first extended layers 41M. Therefore, stress concentration on the first extended conductor 51 in the step of cutting the laminated body block can be suppressed, thus allowing to further reduce the risk of generation of structural defects such as cracks in the laminated inductor 1A.

As illustrated in FIGS. 3 and 4, in the laminated inductor 1A, M=2 and N=2, and two layers of the first non-extended layers 41 N are provided continuously in the lamination direction between two layers of the first extended layers 41M.

As in the laminated inductor 1A illustrated in FIG. 3, when viewed from the lamination direction, the portion constituting the current path of the circling portion R of the first extended layer 41M preferably is same in direction and shape as the portion constituting the current path of the circling portion R of the first non-extended layer 41N.

When the portion constituting the current path of the circling portion R of the first extended layer 41M is same in direction and shape as the portion constituting the current path of the circling portion R of the first non-extended layer 41N as viewed from the lamination direction, the magnetic flux of the coil can be suppressed from being blocked, and thus the impedance can be most efficiently improved. When the portion constituting the current path of the circling portion R of the first extended layer 41M is different in direction or shape from the portion constituting the current path of the circling portion R of the first non-extended layer 41N, the magnetic flux of the coil may be blocked or the magnetic fluxes of the coil may cancel each other in a portion having a different shape between the circling portions R or a portion having a different direction between the circling portions R. Therefore, the impedance of the laminated inductor may decrease.

In addition, when viewed from the lamination direction, when the portion constituting the current path in the circling portion R of the first extended layer 41M is the same in direction and shape as the portion constituting the current path in the circling portion R of the first non-extended layer 41N, it is possible to prevent a difference in current density in the conductor from generating in each first parallel portion P1, and thus, it is possible to suppress deterioration when the laminated inductor 1A is used for a long period of time. When the portion constituting the current path in the circling portion R of the first extended layer 41M is different in direction or shape from the portion constituting the current path in the circling portion R of the first non-extended layer 41N, the ease of flow of the current in each of the first parallel portions P1 may be different. In this case, a large amount of current selectively flows through the first parallel portion P1, which is the path through which the current flows most easily. Therefore, deterioration of the path through which the current most easily flows is accelerated, and thus deterioration of the laminated inductor may easily occur.

The portion constituting the current path in the circling portion R of the first extended layer 41M means a portion of the circling portion R of the first extended layer 41M excluding the dummy electrode through which no current flows. Similarly, the portion constituting the current path in the circling portion R of the first non-extended layer 41N means a portion of the circling portion R of the first non-extended layer 41N excluding the dummy electrode through which no current flows. As illustrated in FIG. 3, there is no dummy electrode through which no current flows in the laminated inductor 1A, and thus the entire circling portion R of the first extended layer 41M constitutes a current path, and the entire circling portion R of the first non-extended layer 41N constitutes a current path.

In the laminated inductor 1A, when viewed from the lamination direction, the circling portion R of the first extended layer 41M is same in direction and shape as the circling portion R of the first non-extended layer 41N. In the laminated inductor 1A, when viewed from the lamination direction, the entire circling portion R of the first extended layer 41M overlaps the entire circling portion R of the first non-extended layer 41N.

In at least one layer of the first extended layer 41M, the width of the portion of the first extended conductor 51, the portion being in contact with the first external electrode 21 is preferably larger than the width of the first parallel portion P1. As illustrated in FIG. 3, in the laminated inductor 1A, in the coil conductor layer CC1 that is the first extended layer 41M, a width A1 of a portion of the first extended conductor 51, the portion being in contact with the first external electrode 21 is larger than a width B1 of the first parallel portion P11. In addition, in the coil conductor layer CC4 that is the first extended layer 41M, a width A4 of a portion of the first extended conductor 51, the portion being in contact with the first external electrode 21 is larger than a width B4 of the first parallel portion P14. Like the laminated inductor 1A, in all of the first extended layers 41M, the width of the portion of the first extended conductor 51, the portion being in contact with the first external electrode 21 is preferably larger than the width of the first parallel portion P1.

When the width of the portion of the first extended conductor 51, the portion being in contact with the first external electrode 21 is larger than the width of the first parallel portion P1, for example, in a case where the laminated body block is cut along the height direction T such that the first end surface 11 of the laminated body 10A becomes a cut surface, the area of the first extended conductor 51 can be increased in a direction perpendicular to the traveling direction of the cutting blade. Therefore, stress concentration in the first extended conductor 51 can be reduced, thus allowing to further reduce the risk of generation of structural defects such as cracks in the laminated inductor 1A.

On the other hand, in the laminated inductor 1A, the number of the first extended layers 41M is smaller than in the configuration in which the first non-extended layers 41N are not present, and thus the resistance in the first extended conductor 51 is increased by the reduction of the first extended layers 41M. Therefore, the width of the portion of the first extended conductor 51, the portion being in contact with the first external electrode 21 is set to be larger than the width of the first parallel portion P1, thereby allowing to suppress an increase in resistance in the first extended conductor 51.

The sum of the widths of the portions of the first extended conductor 51 in the first extended layer 41M, the portions being in contact with the first external electrode 21 is preferably equal to or more than the sum of the widths of the first parallel portions P1 in the first extended layer 41M and the first non-extended layer 41N. As illustrated in FIG. 3, in the laminated inductor 1A, a sum of a width A1 of a portion of the first extended conductor 51, the portion being in the coil conductor layer CC1, the portion being in contact with the first external electrode 21, and a width A4 of a portion of the first extended conductor 51, the portion being in the coil conductor layer CC4, the portion being in contact with the first external electrode 21, is a sum of a width of a portion of the first extended conductor 51, the portion being in the first extended layer 41M, the portion being in contact with the first external electrode 21. In addition, the sum of the widths B1 to B4 of the first parallel portions P11, P12, P13, and P14 of the coil conductor layers CC1, CC2, CC3, and CC4 is the sum of the widths of the first parallel portions P1 in the first extended layer 41M and the first non-extended layer 41N. In the laminated inductor 1A, the sum of the widths of the portions of the first extended conductor 51 in the first extended layer 41M, the portions being in contact with the first external electrode 21 is larger than the sum of the widths of the first parallel portions P1 in the first extended layer 41M and the first non-extended layer 41N. The sum of the widths of the portions of the first extended conductor 51 in the first extended layer 41M, the portions being in contact with the first external electrode 21 may be the same as the sum of the widths of the first parallel portions P1 in the first extended layer 41M and the first non-extended layer 41N.

When the sum of the widths of the portions of the first extended conductor 51 in the first extended layer 41M, the portions being in contact with the first external electrode 21 is equal to or more than the sum of the widths of the first parallel portions P1 in the first extended layer 41M and the first non-extended layer 41N, it is possible to suppress an increase in the current density in the first extended conductor 51 with respect to the current density in the circling portion R. Therefore, generation of electromigration in the first extended conductor 51 can be suppressed.

In the laminated inductor 1A, the width of the first extended conductor 51 is larger in a portion in contact with the first external electrode 21 than in a portion in contact with the circling portion R1. The width of the first extended conductor 51 may be constant.

In the first extended layer 41M, the first extended conductor 51 and the first parallel portion P1 may be directly connected. As illustrated in FIG. 3, in the laminated inductor 1A, the first extended conductor 51 and the first parallel portion P11 are directly connected in the coil conductor layer CC1 that is the first extended layer 41M. Similarly, in the coil conductor layer CC4 that is the first extended layer 41M, the first extended conductor 51 and the first parallel portion P14 are directly connected.

In the first extended layer 41M, the portion connecting the first external electrode 21 and the via conductor V present at the position where the path length to the first external electrode 21 is the shortest may have a linear shape except for the portion in contact with the first external electrode 21.

For example, in the coil conductor layer CC1 that is the first extended layer 41M, the via conductor V1x is a via conductor present at a position where the path length to the first external electrode 21 is the shortest. In the coil conductor layer CC1, a portion of the first extended conductor 51, the portion being in contact with the first external electrode 21 has a large width. In such a case, among the portions between the first external electrode 21 and the via conductor V1x, the portion having the width indicated by B1 in FIG. 3 has a linear shape. Therefore, in the coil conductor layer CC1, it can be said that the portion connecting the first external electrode 21 and the via conductor V1x includes a linear shape except for the portion in contact with the first external electrode 21.

A portion constituting the current path of the circling portion R of the first non-extended layer 41N may include only the first parallel portion P1. In addition, the entire circling portion R of the first non-extended layer 41N may include only the first parallel portion P1. As illustrated in FIG. 3, in the laminated inductor 1A, in the coil conductor layer CC2 that is the first non-extended layer 41N, the entire circling portion R2 includes only the first parallel portion P12. Similarly, in the coil conductor layer CC4 that is the first non-extended layer 41N, the entire circling portion R4 includes only the first parallel portion P14.

In the laminated inductor of the present disclosure, the plurality of coil conductor layers may have K+L layers of the second coil conductor layers continuous in the lamination direction (height direction T in FIG. 3). K and L are natural numbers. Each of the second coil conductor layers has a second parallel portion, and the second parallel portions of the second coil conductor layers adjacent in the lamination direction are connected in parallel with at least two via conductors interposed therebetween.

In the laminated inductor 1A illustrated in FIG. 3, four layers of the coil conductor layers CC5, CC6, CC7, and CC8 are the second coil conductor layers 42. That is, K+L=4 in the laminated inductor 1A illustrated in FIG. 3.

In the laminated inductor 1A, the coil conductor layers CC5, CC6, CC7, and CC8 have second parallel portions P25, P26, P27, and P28, respectively. Hereinafter, the second parallel portion is also collectively referred to as P2.

The second parallel portion P25 of the coil conductor layer CC5 and the second parallel portion P26 of the coil conductor layer CC6 are connected in parallel with the via conductors V5x and V5y interposed therebetween. Similarly, the second parallel portion P26 of the coil conductor layer CC6 and the second parallel portion P27 of the coil conductor layer CC7 are connected in parallel with the via conductors V6x and V6y interposed therebetween. In addition, the second parallel portion P27 of the coil conductor layer CC7 and the second parallel portion P28 of the coil conductor layer CC8 are connected in parallel with via conductors V7x and V7y interposed therebetween.

In the laminated inductor 1A, the entire circling portion R5 of the coil conductor layer CC5 is the second parallel portion P25. Similarly, the entire circling portion R6 of the coil conductor layer CC6 is the second parallel portion P26. In addition, the entire circling portion R7 of the coil conductor layer CC7 is the second parallel portion P27. In addition, the entire circling portion R8 of the coil conductor layer CC8 is the second parallel portion P28.

In the laminated inductor 1A, only both ends of the second parallel portion P2 are connected to the second parallel portion P2 adjacent to each other with the via conductor V interposed therebetween, but a portion other than both ends of the second parallel portion P2 may also be connected to the second parallel portion P2 adjacent to each other with the via conductor interposed therebetween. In this case, the second parallel portions P2 of the adjacent second coil conductor layers 42 are connected to each other with three or more via conductors interposed therebetween. In this manner, the second parallel portions P2 of the adjacent second coil conductor layers 42 may be connected in parallel with at least two via conductors interposed therebetween. Like the laminated inductor 1A, the second parallel portions P2 of the adjacent second coil conductor layers 42 may be connected in parallel with two via conductors interposed therebetween.

Among the second coil conductor layers 42, the K layer is a second extended layer 42K having a second extended conductor 52 connected to the second external electrode 22. As illustrated in FIGS. 3 and 4, in the laminated inductor 1A, two layers of the coil conductor layers CC5 and CC8 are the second extended layer 42K. That is, in the laminated inductor 1A, K=2.

Among the second coil conductor layers 42, the L layer is the second non-extended layer 42L that does not have the second extended conductor 52 connected to the second external electrode 22. As illustrated in FIGS. 3 and 4, in the laminated inductor 1A, two layers of the coil conductor layers CC6 and CC7 are the second non-extended layer 42L. That is, in the laminated inductor 1A, L=2.

When the second coil conductor layer 42 has the second non-extended layer 42L, in a case where the step of manufacturing the laminated inductor 1A includes, for example, a step of cutting the laminated body block along the height direction T such that the second end surface 12 of the laminated body 10A becomes a cut surface, the risk of generation of structural defects such as cracks in the laminated inductor 1A can be reduced.

In the laminated inductor 1A, four layers of the coil conductor layers CC from the second main surface 14 side of the laminated body 10A are the first coil conductor layers 41, and four layers of the coil conductor layers CC from the first main surface 13 side of the laminated body 10A are the second coil conductor layers 42. The second coil conductor layer 42 is provided on the main surface side opposite to the first coil conductor layer 41, and may have the same configuration as the first coil conductor layer 41 except that the extended conductor is connected to the second external electrode 22.

Hereinafter, an example of a method for manufacturing the laminated inductor 1A illustrated in FIGS. 1 to 4 will be described.

### <Producing Process of Magnetic Material>

First, Fe₂O₃, ZnO, CuO, and NiO are weighed so as to have a predetermined ratio.

Then, these weighed materials, pure water, and the like are put in a ball mill together with a media of zirconia with partial stabilization (PSZ), mixed, and then pulverized. Mixing and pulverizing time is, for example, four hours or more and eight hours or less (i.e., from four hours to eight hours).

Then, the obtained pulverized material is dried and then pre-fired. The pre-firing temperature is, for example, 700° C. or more and 800° C. or less (i.e., from 700° C. to 800° C.). The pre-firing time is, for example, two hours or more and five hours or less (i.e., from two hours to five hours).

As described above, a powdery magnetic material, more specifically, a powdery magnetic ferrite material is produced.

As the ferrite material, for example, a Ni—Cu—Zn-based ferrite material is used.

The Ni—Cu—Zn-based ferrite material contains Fe in an amount of 40 mol % or more and 49.5 mol % or less (i.e., from 40 mol % to 49.5 mol %) in terms of Fe₂O₃, Zn in an amount of 2 mol % or more and 35 mol % or less (i.e., from 2 mol % to 35 mol %) in terms of ZnO, Cu in an amount of 6 mol % or more and 13 mol % or less (i.e., from 6 mol % to 13 mol %) in terms of CuO, and Ni in an amount of 10 mol % or more and 45 mol % or less (i.e., from 10 mol % to 45 mol %) in terms of NiO, for example, when the total amount is 100 mol %.

The Ni—Cu—Zn-based ferrite material may further contain an additive such as Co, Bi, Sn, or Mn.

The Ni—Cu—Zn-based ferrite material may further contain inevitable impurities.

### <Producing Process of Green Sheet>

First, a magnetic material, an organic binder such as polyvinyl butyral-based resin, an organic solvent such as ethanol or toluene, a plasticizer, and the like are put in a ball mill together with PSZ media and mixed, and then pulverized to produce slurry.

Then, the slurry is formed into a sheet shape having a predetermined thickness by a doctor blade method or the like, and then punched into a predetermined shape to produce a green sheet. The thickness of the green sheet is, for example, 20 μm or more and 30 μm or less (i.e., from 20 μm to 30 μm). The shape of the green sheet is, for example, a rectangular shape.

As a material of the green sheet, a nonmagnetic material such as a borosilicate glass material may be used instead of the magnetic material, or a mixed material of the magnetic material and the nonmagnetic material may be used.

### <Formation Process of Conductor Pattern>

First, a predetermined portion of the green sheet is irradiated with a laser to form a via hole.

Then, conductive paste such as Ag paste is applied to a surface of the green sheet while the via hole is filled with the conductive paste by a screen printing method or the like. Thereby, a conductor pattern for a coil conductor connected to a conductor pattern for a via conductor is formed on a surface of the green sheet while the conductor pattern for a via conductor is formed in the via hole. As described above, a coil sheet in which the conductor pattern for a coil conductor and the conductor pattern for a via conductor are formed on the green sheet is produced. In the coil sheet, there are formed a conductor pattern for the coil conductor, corresponding to the coil conductor layer CC (including the first extended conductors 51 and 52) illustrated in FIG. 3 and a conductor pattern for the via conductor, corresponding to the via conductor V illustrated in FIG. 3.

### <Producing Process of Laminated Body Block>

The coil sheets are laminated in the lamination direction (herein, from the negative direction to the positive direction in the height direction T) in the order corresponding to FIG. 3, and then thermocompression-bonded to produce a laminated body block.

### <Step of Producing Laminated Body and Coil>

First, the laminated body block is cut into a predetermined size by a method such as press-cutting or dicer cutting, thereby producing a singulated chip.

Then, the singulated chip is fired. The firing temperature is, for example, 900° C. or more and 920° C. or less (i.e., from 900° C. to 920° C.). The firing time is, for example, two hours or more and four hours or less (i.e., from two hours to four hours).

When the singulated chip is fired, the green sheet of the coil sheet becomes an insulating layer.

In addition, when the singulated chip is fired, the conductor pattern for the coil conductor and the conductor pattern for the via conductor become a coil conductor and a via conductor, respectively. This produces a coil in which a plurality of coil conductors laminated together with the insulating layer is electrically connected with the via conductor interposed therebetween.

As described above, there is produced a laminated body in which a plurality of insulating layers are laminated in the lamination direction and a coil is provided inside.

The laminated body is subjected to, for example, barrel polishing, whereby a corner portion and a ridge portion may be rounded.

### <Step of Forming External Electrode>

First, a conductive paste such as a paste containing Ag and glass frit is applied to the end surface from which the coil is drawn out of the outer surface of the laminated body to form a conductive paste layer.

Then, the conductive paste layer is baked to form an underlying electrode of the external electrode. The baking temperature is, for example, 800° C. or more and 820° C. or less (i.e., from 800° C. to 820° C.). The thickness of the underlying electrode is, for example, 5 μm.

Then, a Ni plated electrode and a Sn plated electrode are formed in order on a surface of the underlying electrode by electrolytic plating or the like. This forms an external electrode including the underlying electrode, the Ni plating electrode, and the Sn plating electrode in this order.

As described above, the laminated inductor 1A is manufactured.

The size of the laminated inductor 1A is, for example, 2.0 mm in the length direction L, 1.25 mm in the width direction W, and 1.25 mm in the height direction T.

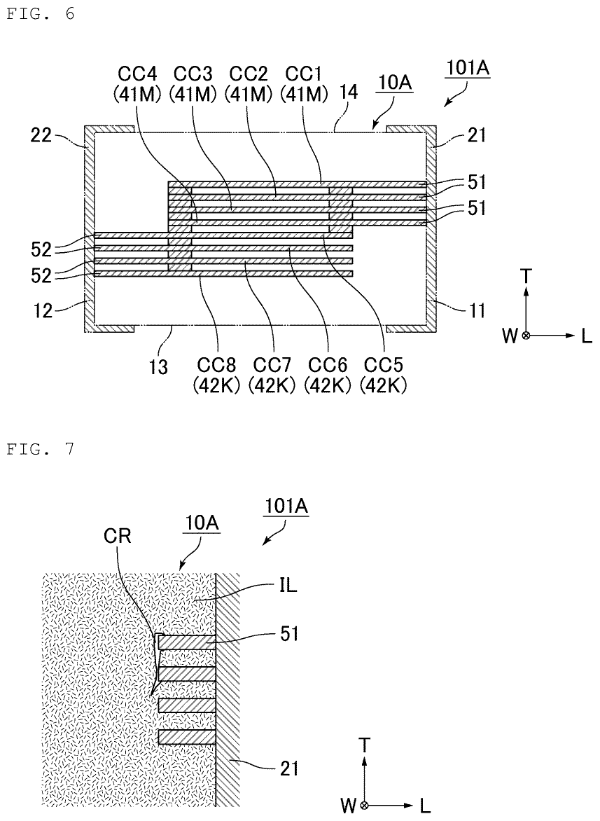

FIG. 5 is a view illustrating a laminated inductor of a comparative example in a perspective view in a height direction.

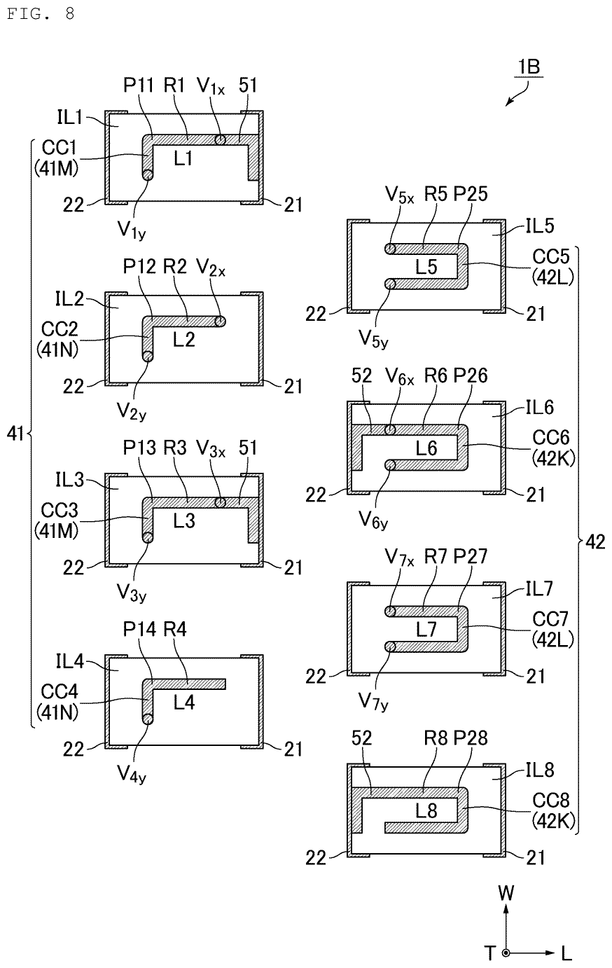

FIG. 6 is a view illustrating a laminated inductor of a comparative example in a perspective view in a width direction.

As illustrated in FIG. 5, in the laminated inductor 101A of the comparative example, the laminated body 10A has a coil 30A therein.

The coil 30A has a first extended conductor 51 and a second extended conductor 52. The coil 30A is connected to the first external electrode 21 with the first extended conductor 51 interposed therebetween. The coil 30A is connected to the second external electrode 22 with the second extended conductor 52 interposed therebetween.

As illustrated in FIG. 6, in the laminated inductor 101A of the comparative example, all of the coil conductor layers CC1, CC2, CC3, and CC4 are the first extended layer 41M having the first extended conductor 51. In addition, all of the coil conductor layers CC5, CC6, CC7, and CC8 are the second extended layer 42K having the second extended conductor 52. The laminated inductor 101A of the comparative example has the same configuration as the laminated inductor 1A except that the number of first extended conductors 51 included in the coil 30A and the number of second extended conductors 52 included in the coil 30A are different.

In the laminated inductor 101A of the comparative example, four layers of the first extended conductors 51 are continuously overlapped on the first end surface 11 of the laminated body 10A. A method for manufacturing the laminated inductor 101A of the comparative example may include a step of cutting the laminated body block along the height direction T such that the first end surface 11 of the laminated body 10A becomes a cut surface. In this case, in the laminated inductor 101A of the comparative example, a metal component such as Ag, which is a material of the first extended conductor 51, increases in the cutting direction as compared with the laminated inductor 1A. The metal component such as Ag has not only a higher elastic modulus but also a smaller breaking strain than the ferrite material or the like constituting the insulating layer IL. Therefore, in the laminated inductor 101A in which a large amount of metal component such as Ag is contained in the cut surface, there is increased the risk of generation of structural defects such as cracks due to stress generated in the traveling direction of the cutting blade.

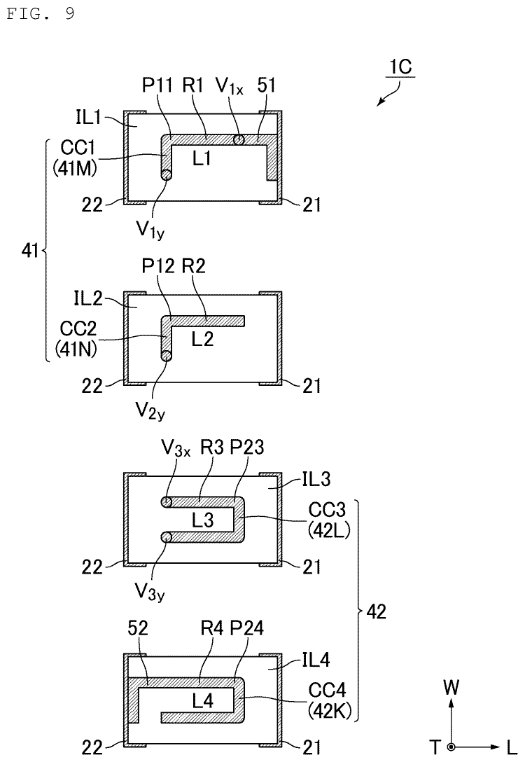

FIG. 7 is a schematic view illustrating a first extended conductor in an enlarged manner in a sectional taken along line VII-VII in FIG. 5.

In the example illustrated in FIG. 7, there is generated a crack CR passing through the interface between the first extended conductor 51 and the insulating layer IL. In the laminated inductor 101A, there may be generated not only the crack CR passing through the interface between the first extended conductor 51 and the insulating layer IL as illustrated in FIG. 7 but also the crack CR with the first extended conductor 51 itself broken. The structural defect such as the crack CR generating in the laminated inductor 101A increases a risk of disconnection or the like during use of the laminated inductor 101A, and thus reliability of the laminated inductor 101A is deteriorated.

### Second Embodiment

In the laminated inductor according to the second embodiment of the present disclosure, the first extended layer and the first non-extended layer are alternately provided in the lamination direction.

FIG. 8 is an exploded plan view schematically illustrating an example of a laminated inductor according to the second embodiment of the present disclosure.

The laminated inductor 1B illustrated in FIG. 8 has a configuration in which the coil conductor layer CC3 of the third layer L3 and the coil conductor layer CC4 of the fourth layer L4 in the laminated inductor 1A are interchanged, and the coil conductor layer CC5 of the fifth layer L5 and the coil conductor layer CC6 of the sixth layer L6 are interchanged. Except for the above points, the laminated inductor 1B has the same configuration as the laminated inductor 1A.

In the laminated inductor 1B illustrated in FIG. 8, four layers of the coil conductor layers CC1, CC2, CC3, and CC4 are the first coil conductor layers 41. That is, M+N=4 in the laminated inductor 1B illustrated in FIG. 8.

As illustrated in FIG. 8, in the laminated inductor 1B, two layers of the coil conductor layers CC1 and CC3 are the first extended layer 41M. That is, in the laminated inductor 1B, M=2.

As illustrated in FIG. 8, in the laminated inductor 1B, two layers of the coil conductor layers CC2 and CC4 are the first non-extended layer 41N. That is, in the laminated inductor 1B, N=2.

In the laminated inductor 1B illustrated in FIG. 8, the first extended layer 41M and the first non-extended layer 41N are alternately provided in the lamination direction (herein, the height direction T). When the first extended layers 41M and the first non-extended layers 41N are alternately provided in the lamination direction, the first extended layers 41M are not present continuously in the lamination direction. Therefore, it is possible to further reduce the risk of generation of structural defects such as cracks in the laminated inductor 1B.

When the first extended layer 41M and the first non-extended layer 41N are alternately provided in the lamination direction, M+N is a natural number of 3 or more. Although not illustrated, when M+N is 3, one first non-extended layer 41N may be provided between one set of first extended layers 41M, and one first extended layer 41M may be provided between one set of first non-extended layers 41N.

As in the laminated inductor 1B illustrated in FIG. 8, there may be a plurality of first extended layers 41M, and the first extended layers 41M and the first non-extended layers 41N may be alternately provided in the lamination direction. In this case, the first non-extended layer 41N is present between each of the plurality of first extended layers 41M. Therefore, multiple insulating layers IL including ferrite or the like having a low elastic modulus and a large breaking strain are sandwiched between the first extended layers 41M. Therefore, stress concentration on the first extended conductor 51 in the step of cutting the laminated body block can be suppressed, thus allowing to further reduce the risk of generation of structural defects such as cracks in the laminated inductor 1B.

In the laminated inductor 1B illustrated in FIG. 8, the second extended layer 42K and the second non-extended layer 42L are alternately provided in the lamination direction. When the second extended layers 42K and the second non-extended layers 42L are alternately provided in the lamination direction, the second extended layers 42K are not present continuously in the lamination direction. Therefore, it is possible to further reduce the risk of generation of structural defects such as cracks in the laminated inductor 1B.

### Third Embodiment

In the laminated inductor according to the third embodiment of the present disclosure, each one layer of the first extended layer and the first non-extended layer is present.

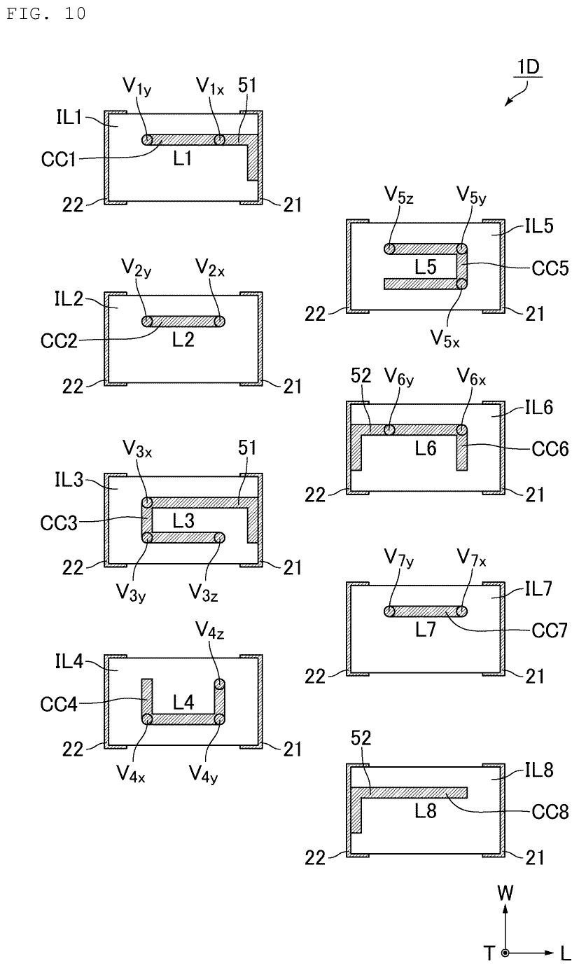

FIG. 9 is an exploded plan view schematically illustrating an example of a laminated inductor according to the third embodiment of the present disclosure.

The laminated inductor 1C illustrated in FIG. 9 has a configuration in which the coil conductor layer CC3 of the third layer L3, the coil conductor layer CC4 of the fourth layer L4, the coil conductor layer CC5 of the fifth layer L5, and the coil conductor layer CC6 of the sixth layer L6 in the laminated inductor 1A are removed. Except for the above points, the laminated inductor 1C has the same configuration as the laminated inductor 1A.

In the laminated inductor 1C illustrated in FIG. 9, two layers of the coil conductor layers CC1 and CC2 are the first coil conductor layers 41. That is, M+N=2 in the laminated inductor 1C illustrated in FIG. 9.

As illustrated in FIG. 9, in the laminated inductor 1C, one layer of the coil conductor layers CC1 is the first extended layer 41M. That is, in the laminated inductor 1C, M=1.

As illustrated in FIG. 9, in the laminated inductor 1C, one layer of the coil conductor layers CC2 is the first non-extended layer 41N. That is, in the laminated inductor 1C, N=1.

In the laminated inductor 1C illustrated in FIG. 9, two layers of the coil conductor layers CC3 and CC4 are the second coil conductor layers 42. That is, K+L=2 in the laminated inductor 1C illustrated in FIG. 9.

As illustrated in FIG. 9, in the laminated inductor 1C, one layer of the coil conductor layers CC4 is the second extended layer 42K. That is, in the laminated inductor 1C, K=1.

As illustrated in FIG. 9, in the laminated inductor 1C, one layer of the coil conductor layers CC3 is the second non-extended layer 42L. That is, in the laminated inductor 1C, L=1.

### Fourth Embodiment

In the laminated inductor according to the fourth embodiment of the present disclosure, a part of the coil conductor layer being present between the first coil conductor layer and the second coil conductor layer is connected in parallel.

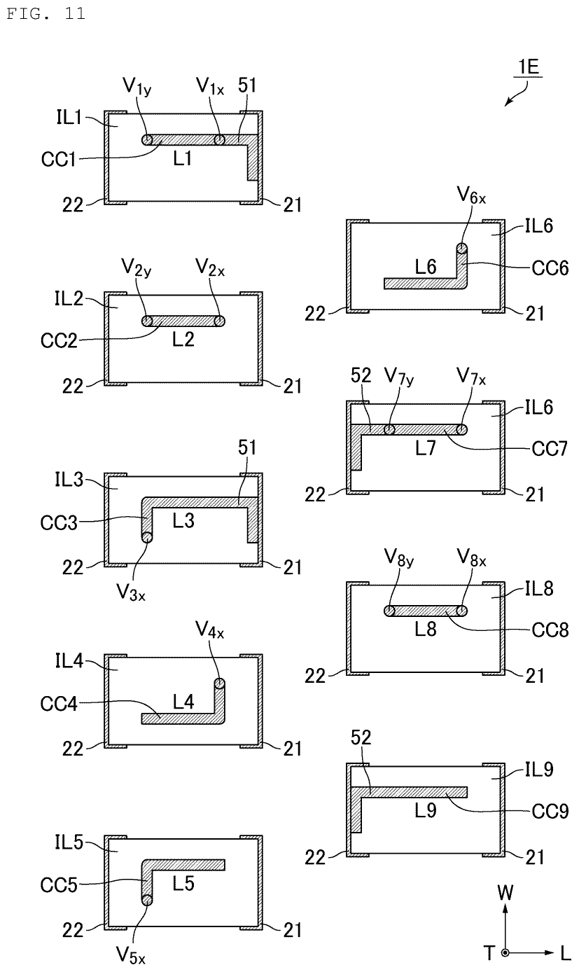

FIG. 10 is an exploded plan view schematically illustrating an example of a laminated inductor according to the fourth embodiment of the present disclosure.

In the laminated inductor 1D illustrated in FIG. 10, the coil conductor layers CC1, CC2, CC3, CC4, CC5, CC6, CC7, and CC8 are electrically connected with the via conductors V1x, Vy, V2x, V2y, V3x, V3y, V3z, V4x, V4y, V4z, V5x, V5y, V5z, V6x, V6y, V7x, and V7y interposed therebetween.

In the laminated inductor 1D illustrated in FIG. 10, the coil conductor layer CC4 of the fourth layer L4 is present between the first coil conductor layer and the second coil conductor layer. A part of the coil conductor layer CC4 is connected in parallel with the coil conductor layer adjacent in the lamination direction.

A part of the coil conductor layer CC4 is connected in parallel with a part of the coil conductor layer CC3 of the third layer L3 with the via conductors V3x, V3y, and V3z interposed therebetween. In addition, a part of the coil conductor layer CC4 is connected in parallel with a part of the coil conductor layer CC5 of the fifth layer L5 with the via conductors V4x, V4y, and V4z interposed therebetween.

In the laminated inductor 1D, the coil conductor layer being present between the first coil conductor layer and the second coil conductor layer is connected in parallel, and thus the direct current resistance can be reduced. In addition, only a part of the coil conductor layer being present between the first coil conductor layer and the second coil conductor layer is connected in parallel, and thus the number of via conductors overlapping in the lamination direction can be reduced. Therefore, it is possible to suppress a crack generated during firing the laminated inductor 1D due to overlapping of multiple via conductors in the lamination direction.

### Fifth Embodiment

In the laminated inductor according to the fifth embodiment of the present disclosure, the coil conductor layer being present between the first coil conductor layer and the second coil conductor layer is connected in series.

FIG. 11 is an exploded plan view schematically illustrating an example of a laminated inductor according to the fifth embodiment of the present disclosure.

In the laminated inductor 1E illustrated in FIG. 11, the coil conductor layers CC1, CC2, CC3, CC4, CC5, CC6, CC7, CC8, and CC9 are electrically connected with via conductors V1x, Vy, V2x, V2y, V3x, V4x, V5x, V6x, V7x, V7y, V8x, and V8y interposed therebetween.

In the laminated inductor 1E illustrated in FIG. 11, the coil conductor layer CC4 of the fourth layer L4, the coil conductor layer CC5 of the fifth layer L5, and the coil conductor layer CC6 of the sixth layer L6 are present between the first coil conductor layer and the second coil conductor layer. The coil conductor layer CC4, the coil conductor layer CC5, and the coil conductor layer CC6 are each connected in series.

In the laminated inductor 1E illustrated in FIG. 11, the first coil conductor layer has the parallel portion, and thus current concentration can be reduced in the first coil conductor layer. In addition, the first coil conductor layer has the first non-extended layer, and thus stress concentration in the first extended conductor 51 in the step of cutting the laminated body block can be suppressed. The laminated inductor 1E illustrates an example of a laminated inductor in which the coil conductor layers being present between the first coil conductor layer and the second coil conductor layer are connected in series while exhibiting the above effect.

The laminated inductor of the present disclosure is not limited to the above embodiment, and various applications and modifications can be made within the scope of the present disclosure with respect to the configuration, manufacturing conditions, and the like of the laminated inductor.

In the laminated inductor of the present disclosure, M and N may be the same or different.

When the laminated inductor of the present disclosure has the second coil conductor layer, K and L may be the same or different. In addition, M and K may be the same or different. Similarly, N and L may be the same or different.

When the laminated inductor of the present disclosure has the second coil conductor layer, there may be no other coil conductor layer between the first coil conductor layer and the second coil conductor layer as in the first to third embodiments, or there may be another coil conductor layer as in the fourth and fifth embodiments. For example, when the third coil conductor layer is present between the first coil conductor layer and the second coil conductor layer, the configuration of the third coil conductor layer is not particularly limited.

Content below is disclosed in the present description.
<1> A laminated inductor, including a laminated body in which a plurality of insulating layers are laminated in a lamination direction and a coil is provided inside; and a first external electrode and a second external electrode provided on an outer surface of the laminated body and electrically connected to the coil. The coil is configured by electrically connecting a plurality of coil conductor layers laminated in the lamination direction together with the insulating layer. The plurality of coil conductor layers have M+N layers (M and N are natural numbers) of first coil conductor layers continuous in the lamination direction. Each of the first coil conductor layers has a first parallel portion. The first parallel portions of the first coil conductor layers adjacent to each other in the lamination direction are connected in parallel with at least two via conductors interposed therebetween. Also, M layers in the first coil conductor layers are each a first extended layer having a first extended conductor connected to the first external electrode, and N layers are each a first non-extended layer not having the first extended conductor, where M is a natural number of 2 or more. At least one layer of the first non-extended layer is present between at least one set of the first extended layers in the lamination direction.
<2> A laminated inductor, including a laminated body in which a plurality of insulating layers are laminated in a lamination direction and a coil is provided inside; and a first external electrode and a second external electrode provided on an outer surface of the laminated body and electrically connected to the coil. The coil is configured by electrically connecting a plurality of coil conductor layers laminated in the lamination direction together with the insulating layer. The plurality of coil conductor layers have M+N layers (M and N are natural numbers) of first coil conductor layers continuous in the lamination direction. Each of the first coil conductor layers has a first parallel portion. The first parallel portions of the first coil conductor layers adjacent to each other in the lamination direction are connected in parallel with at least two via conductors interposed therebetween. Also, M layers in the first coil conductor layers are each a first extended layer having a first extended conductor connected to the first external electrode, and N layers are each a first non-extended layer not having the first extended conductor. When viewed from the lamination direction, a portion constituting a current path in a circling portion of the first extended layer is the same in orientation and shape as a portion constituting a current path in a circling portion of the first non-extended layer.
<3> The laminated inductor according to <2>, wherein in the first extended layer, a portion connecting the first external electrode and the via conductor present at a position where the path length to the first external electrode is shortest has a linear shape except for a portion in contact with the first external electrode.
<4> The laminated inductor according to <2> or <3>, wherein M is a natural number of 2 or more, and at least one layer of the first non-extended layer is present between at least one set of the first extended layers in the lamination direction.
<5> The laminated inductor according to any one of <1> to <4>, wherein a width of a portion of the first extended conductor in at least one layer of the first extended layer, the portion being in contact with the first external electrode, is larger than a width of the first parallel portion.
<6> The laminated inductor according to any one of <1> to <5>, wherein a sum of widths of portions of the first extended conductor in the first extended layer, the portions being in contact with the first external electrode, is equal to or more than a sum of widths of the first parallel portions in the first extended layer and the first non-extended layer.
<7> The laminated inductor according to any one of <1> to <6>, wherein M+N is a natural number of 3 or more, and two or more layers of the first extended layers are not continuous in the lamination direction.
<8> The laminated inductor according to <7>, wherein M+N is a natural number of 3 or more, and the first extended layer and the first non-extended layer are alternately provided in the lamination direction.
<9> The laminated inductor according to <7>, wherein M=2 and N=2, and two layers of the first non-extended layers are provided continuously in the lamination direction between two layers of the first extended layers.
<10> The laminated inductor according to any one of <1> to <9>, wherein the first extended conductor and the first parallel portion are directly connected in the first extended layer.
<11> The laminated inductor according to any one of <1> to <10>, wherein a portion constituting a current path in the circling portion of the first non-extended layer includes only the parallel portion.
<12> The laminated inductor according to any one of <1> to <11>, wherein the plurality of coil conductor layers have K+L layers (K and L are natural numbers) of second coil conductor layers continuous in the lamination direction, each of the second coil conductor layers has a second parallel portion, and the second parallel portions of the second coil conductor layers adjacent to each other in the lamination direction are connected in parallel with at least two via conductors interposed therebetween. Also, K layers in the second coil conductor layers are each a second extended layer having a second extended conductor connected to the second external electrode, and L layers are each a second non-extended layer not having the second extended conductor.

What is claimed is:

1. A laminated inductor, comprising:
a laminated body including a plurality of insulating layers laminated in a lamination direction, and a coil inside the laminated body; and
a first external electrode and a second external electrode on an outer surface of the laminated body and electrically connected to the coil,
wherein
the coil is configured by electrically connecting a plurality of coil conductor layers laminated in the lamination direction together with the insulating layer,
the plurality of coil conductor layers have M+N layers (M and N are natural numbers) of first coil conductor layers continuous in the lamination direction,
each of the first coil conductor layers has a first parallel portion,
the first parallel portions of the first coil conductor layers adjacent to each other in the lamination direction are connected in parallel with at least two via conductors interposed therebetween,
M layers in the first coil conductor layers are each a first extended layer having a first extended conductor connected to the first external electrode, and N layers are each a first non-extended layer not having the first extended conductor,
M is a natural number of 2 or more, and
at least one layer of the first non-extended layer is present between at least one set of the first extended layers in the lamination direction.

2. A laminated inductor, comprising:
a laminated body including a plurality of insulating layers laminated in a lamination direction, and a coil inside the laminated body; and
a first external electrode and a second external electrode on an outer surface of the laminated body and electrically connected to the coil,
wherein
the coil is configured by electrically connecting a plurality of coil conductor layers laminated in the lamination direction together with the insulating layer,
the plurality of coil conductor layers have M+N layers (M and N are natural numbers) of first coil conductor layers continuous in the lamination direction,
each of the first coil conductor layers has a first parallel portion,
the first parallel portions of the first coil conductor layers adjacent to each other in the lamination direction are connected in parallel with at least two via conductors interposed therebetween,
M layers in the first coil conductor layers are each a first extended layer having a first extended conductor connected to the first external electrode, and N layers are each a first non-extended layer not having the first extended conductor, and
when viewed from the lamination direction, a portion defining a current path in a circling portion of the first extended layer is the same in orientation and shape as a portion defining a current path in a circling portion of the first non-extended layer.

3. The laminated inductor according to claim 2, wherein
in the first extended layer, a portion of the first extended conductor connecting the first external electrode and the via conductor which is located at a position where a path length from the via conductor to the first external electrode is shortest has a linear shape except for a portion of first extended conductor in contact with the first external electrode.

4. The laminated inductor according to claim 2, wherein
M is a natural number of 2 or more, and
at least one layer of the first non-extended layer is between at least one set of the first extended layers in the lamination direction.

5. The laminated inductor according to claim 1, wherein
a width of a portion of the first extended conductor which is in contact with the first external electrode is larger than a width of the first parallel portion in at least one layer of the first extended layer.

6. The laminated inductor according to claim 1, wherein
a sum of widths of portions of the first extended conductor which are in contact with the first external electrode in the first extended layer is equal to or greater than a sum of widths of the first parallel portions in the first extended layer and in the first non-extended layer.

7. The laminated inductor according to claim 1, wherein
M+N is a natural number of 3 or more, and
two or more layers of the first extended layers are not continuous in the lamination direction.

8. The laminated inductor according to claim 7, wherein
M+N is a natural number of 3 or more, and
the first extended layer and the first non-extended layer are alternately provided in the lamination direction.

9. The laminated inductor according to claim 7, wherein
M=2 and N=2, and
two layers of the first non-extended layers are continuously provided in the lamination direction between two layers of the first extended layers.

10. The laminated inductor according to claim 1, wherein
the first extended conductor and the first parallel portion are directly connected in the first extended layer.

11. The laminated inductor according to claim 1, wherein
a portion defining a current path in a circling portion of the first non-extended layer includes only the parallel portion.

12. The laminated inductor according to claim 1, wherein
the plurality of coil conductor layers have K+L layers (K and L are natural numbers) of second coil conductor layers continuous in the lamination direction,
each of the second coil conductor layers has a second parallel portion,
the second parallel portions of the second coil conductor layers adjacent to each other in the lamination direction are connected in parallel with at least two via conductors interposed therebetween, and
in the second coil conductor layers, each of K layers is a second extended layer having a second extended conductor connected to the second external electrode, and each of L layers is a second non-extended layer not having the second extended conductor.

13. The laminated inductor according to claim 3, wherein
M is a natural number of 2 or more, and
at least one layer of the first non-extended layer is between at least one set of the first extended layers in the lamination direction.

14. The laminated inductor according to claim 2, wherein
a width of a portion of the first extended conductor which is in contact with the first external electrode is larger than a width of the first parallel portion in at least one layer of the first extended layer.

15. The laminated inductor according to claim 3, wherein
a width of a portion of the first extended conductor which is in contact with the first external electrode is larger than a width of the first parallel portion in at least one layer of the first extended layer.

16. The laminated inductor according to claim 2, wherein
a sum of widths of portions of the first extended conductor which are in contact with the first external electrode in the first extended layer is equal to or greater than a sum of widths of the first parallel portions in the first extended layer and in the first non-extended layer.

17. The laminated inductor according to claim 2, wherein
M+N is a natural number of 3 or more, and
two or more layers of the first extended layers are not continuous in the lamination direction.

18. The laminated inductor according to claim 2, wherein
the first extended conductor and the first parallel portion are directly connected in the first extended layer.

19. The laminated inductor according to claim 2, wherein
a portion defining a current path in a circling portion of the first non-extended layer includes only the parallel portion.

20. The laminated inductor according to claim 2, wherein
the plurality of coil conductor layers have K+L layers (K and L are natural numbers) of second coil conductor layers continuous in the lamination direction,
each of the second coil conductor layers has a second parallel portion,
the second parallel portions of the second coil conductor layers adjacent to each other in the lamination direction are connected in parallel with at least two via conductors interposed therebetween, and
in the second coil conductor layers, each of K layers is a second extended layer having a second extended conductor connected to the second external electrode, and each of L layers is a second non-extended layer not having the second extended conductor.
